(19) United States
(12) Patent Application Publication
(10) Pub. No.: US 2007/0140043 A1
(43) Pub. Date: Jun. 21, 2007

(54) Method and apparatus of combining food particles and ice cream

(76) Inventors: Stan Jones, Vienna, IL (US); Curt Jones, Brentwood, TN (US)

Correspondence Address: STOCKWELL & SMEDLEY, PSC, 861 CORPORATE DRIVE, SUITE 200, LEXINGTON, KY, 40503, US

(21) Appl. No.: 11/305,612

(22) Filed: Dec. 16, 2005

(51) Int. Cl. B01F 15/06

(52) U.S. Cl. 366/144

(57) ABSTRACT

An apparatus and method for combining cryogenically frozen food particles and traditional conventional ice cream is disclosed.

### CROSS REFERENCE TO RELATED APPLICATIONS

This patent application claims priority to PCT Application No. PCT/US2004/031006, filed on Sep. 21, 2004, which in turn claims priority to U.S. Provisional Patent Application No. 60/505,559, filed on Sep. 24, 2003.

### FIELD OF THE INVENTION

The present invention relates to ice cream and more particularly to an apparatus and method for combining food particles within ice cream.

### BACKGROUND OF THE INVENTION

Conventional ice cream has existed for many years in many embodiments. Food particles that have been cryogenically frozen are not as ubiquitous in the marketplace. However, attempts to combine the two have been rare because the process of making conventional ice cream differs substantially from cryogenically freezing food particles. Consequently, a method and apparatus for combining the two entities is desired.

### BRIEF DESCRIPTION OF THE DRAWINGS

FIG. 1 shows a portion of the present invention;

FIG. 2 shows a first embodiment of the present invention;

FIGS. 3 and 4 show a second embodiment of the present invention; and

FIGS. 5A and 5B show an exemplary packaging technique of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

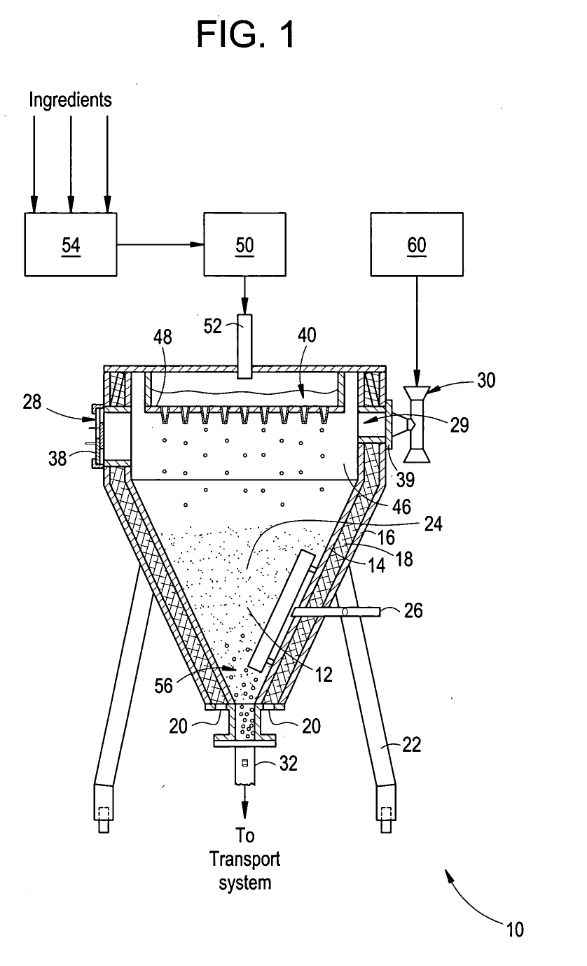

FIG. 1 shows a cryogenic processor constructed in accordance with the preferred embodiment of the present invention to produce free-flowing food particles 56. The fundamental method utilized to produce the product is described in detail in U.S. Pat. No. 5,126,156, which is hereby incorporated by reference.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen food particles occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particles or food particles 56 of frozen product, uniformly sized droplets of liquid composition are required to be fed through gas diffusion chamber 46 to freezing chamber 12. The feed tray 48 is designed with feed assembly 40 that forms droplets of the desired character. The frozen product takes the form of food particles that are formed when the droplets 58 of liquid composition contact the refrigerant vapor in the gas diffusion chamber 46, and subsequently the liquid refrigerant 24 in the freezing chamber 12. After the food particles 56 are formed, they fall to the bottom of chamber 12. A transport system connects to the bottom of chamber 12 at outlet 32 to carry the food particles 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow required.

A feed tray 48 receives the food particles 56 from a delivery source 50. These food particles 56 can include cranberries, pieces of other fruit, pieces of chocolate, various types of candies, pieces of cookie dough, or any of the above covered in chocolate. The cookie dough can be pre-cut into predetermined shapes such as cubes, triangles, or hearts. In a cubical embodiment, the dough shapes are formed to measure 5/16″× 5/16″× 5/16″, so as to achieve an appropriate ratio between the shapes and other typical food particles, as well as to blend well within the ice cream.

It has been long established practice that when making traditional conventional ice cream, the ice cream must be held in a freezing cold “hardening cabinet” for 2, 4, or maybe 8 hours prior to shipping or delivery. However, because the food particles 56 of the present invention are frozen at substantially lower temperatures than conventional ice cream, the interspersing of the ultra-cold food particles 56 within the conventional ice cream negates or greatly reduces this requirement.

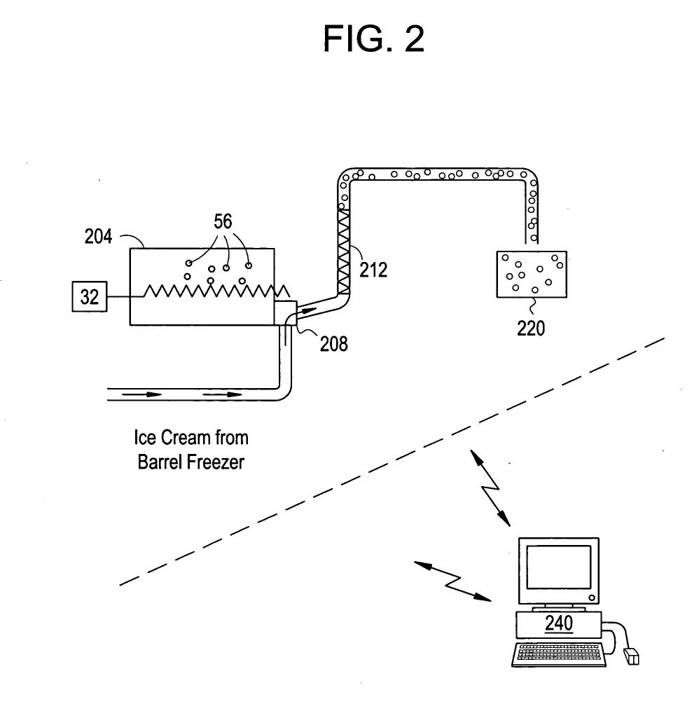

FIG. 2 shows an exemplary apparatus for blending food particles and conventional ice cream. In FIG. 2, the food particles 56 are fed into a variable speed fruit and nut feeder 204 either directly from the outlet 32 or from a transport mechanism. In either case, the food particles 56 are combined with the semi-frozen soft ice cream from a barrel freezer (not shown) by a combining mechanism 208 such as but not limited to a star wheel, which forces the combination through a static mixer 212 where it is blended and then output into a container 220 either for consumption, shipping, or temporary storage within a hardening cabinet. The combining mechanism 208 ensures that a pre-configurable percentage of food particles 56 are inserted into the semi-frozen soft ice cream, yet regulates the pressure and flow such that the food particles 56 are not crushed. Additionally, the soft combination does not become too viscous to pump properly.

In an exemplary embodiment, the combining mechanism 208 feeds back information to a central control device 240 which can automatically make real-time adjustments to both the variable speed fruit and nut feeder 204 as well as a mechanism which controls the flow of the semi-liquid conventional ice cream from the barrel freezer. An operator may also use the central control device 240 to make manual adjustments.

As shown in FIG. 2, the central control device 240 may be located at a standard room temperature environment separate from the food-preparation environment, and information communicated thereto could be wirelessly or remotely transmitted to the combining mechanism 208 and other mechanisms via communication means such as but not limited to WiFi or Bluetooth.

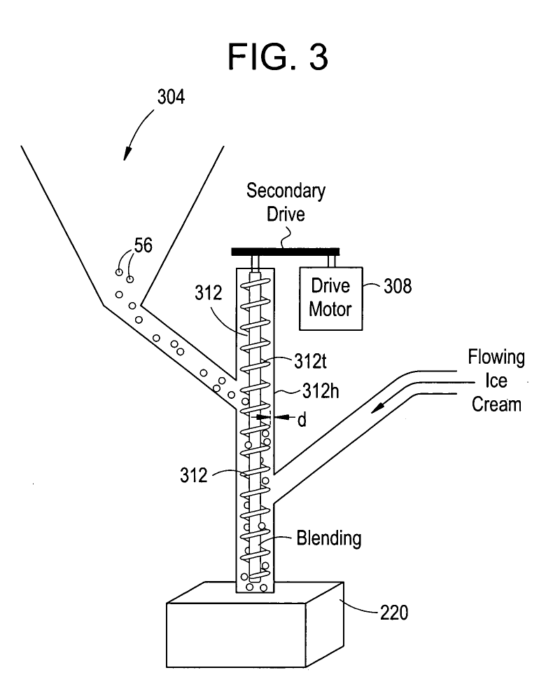

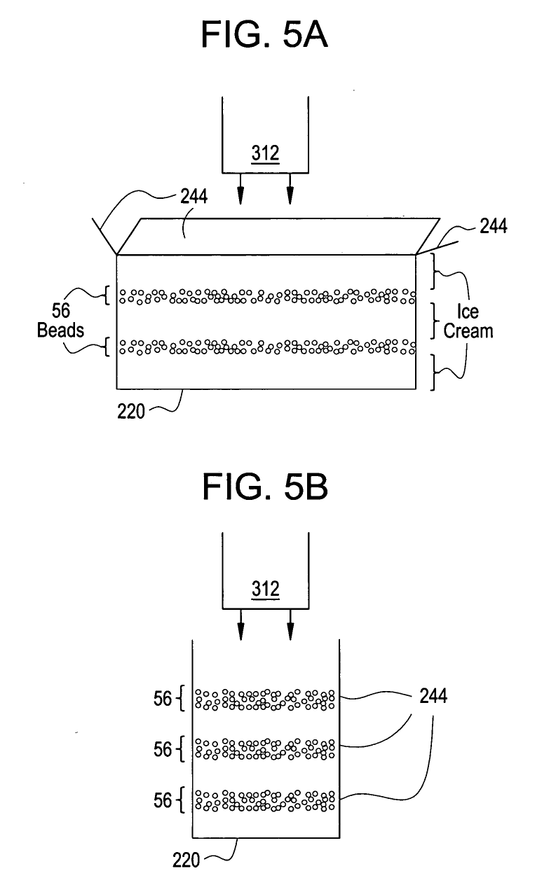

FIG. 3 (not to scale) shows an alternative embodiment of the present invention in which the fruit and nut feeder 204 is not used, but instead the food particles 56 are gravity fed into a screw-drive apparatus 312 powered by a drive motor 308. Using the screw-drive apparatus 312, a container 220 can be filled first with a layer of food particles 56, then a layer of semi-frozen soft ice cream, then another layer of food particles 56, and then a layer of something else, and so on. In this way a variety of aesthetically pleasing packaging effects can be obtained, as shown in FIGS. 5A and 5B. For conciseness, the screw-drive apparatus 312 is not drawn to scale. However, it is important to note that the distance ‘d’ between the threads 312t of the feed screw and the screw housing 312h is small enough that the food particles 56 only advance when the feed screw is rotating. This feature is not clearly discernable from FIG. 3, because portions of FIG. 3 are exaggerated for clarity.

FIG. 5A shows the horizontal layering alternating food particles and conventional ice cream described above. However, because the layering effect is not immediately visible to a purchaser upon opening the container 220, FIG. 5B shows an alternate embodiment in which the container 220 is filled from the side rather than from the top, and sealed in such a way that a customer will be immediately presented with a striped pattern of alternating layers of food particles 56 and conventional ice cream upon opening the container 220. During the time the container 220 of FIG. 5B is filled, the re-usable flaps 244 are closed. However, during the time the container 220 of FIG. 5A is filled, the flaps 244 are open.

Additionally, the packaging suggestion of FIG. 5A could be packaged in a translucent plastic container 220T which makes the horizontally layered contents eminently visible to a potential customer while on display in a typical retail environment such as dairy case at a supermarket. In any configuration where food particles are layered within alternating layers of conventional ice cream, it is important that the interior of the mixing apparatus 312 be appropriately evacuated between layers of the dissimilar ice cream compounds, so that a sharp, crisp visual transition between the resulting layers occurs.

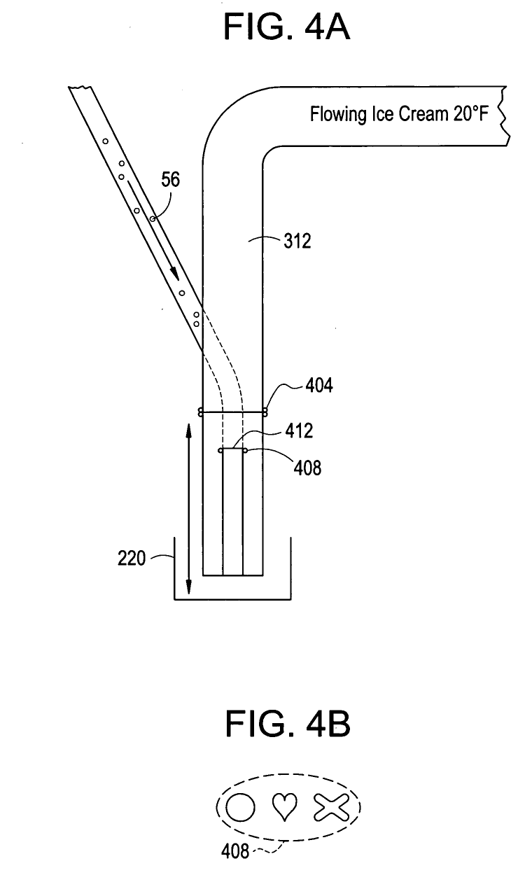

FIG. 4 shows a variation of the embodiment shown in FIG. 3, in which a twist-lock changeable pattern mechanism 408 is added to the screw-drive apparatus 312. The pattern mechanism 408 could also be fitted to the output of the static mixer 212. The pattern mechanism 408 allows the inscribing of configurable patterns of food particles 56 within the conventional ice cream. Various shapes including but not limited to those shown in FIG. 4 are possible, as well as letters, caricatures, and other artistic renderings. Such a feature could be a useful marketing device around holidays such as Valentine's Day, Halloween, and Christmas.

The pattern mechanism 408 works as follows. The food particles 56 are forced through a changeable pattern stencil 412 which starts out at the bottom of the empty container 220 and is raised at the same rate that the container 220 is filled. The rate at which the food particles 56 and conventional ice cream are pumped into the pattern mechanism 408 and the container 220 must be are carefully monitored and controlled, potentially by the central control device 240 although not limited thereto, using information obtained from sensors within the pattern mechanism 408. Such control is needed in order to accurately reproduce the desired pattern throughout the entire container 220.

An additional alternative embodiment exists in which the food particles 56 are swirled into the flowing ice cream by modifying the mixing apparatus 312 of FIG. 3. The modified mixing apparatus contains two separate output nozzles, rather than a single output such as that shown in FIG. 3. In such an embodiment, the food particles 56 are dropped into the container 220 which is simultaneously but separately being filled with conventional ice cream. The nozzle for the food particles 56 can be adapted to rotate, zigzag, or move in a variety of directions so that the food particles are swirled, spirally deposited, or linear deposited in some other type of recognizable pattern involving pre-arranged lines and curves.

The various aspects of the present invention has been described in detail with particular reference to preferred embodiments thereof, but it will be understood that variations and modifications can be effected within the spirit and scope of the invention as described herein. It is anticipated that various changes may be made in the arrangement of the system of the present invention without departing from the spirit and scope of the invention, as defined by the following claims.

What is claimed is:

1. A mechanism for combining particulate and conventional ice cream, comprising:
a cryogenic processor containing a refrigerant and having input and output locations, wherein the processor receives liquid composition at the input location, and transforms the liquid composition into frozen food particles which are movably directed toward the output location;
an ingredient feeder, such as a fruit and nut feeder, having first and second input apertures and an output aperture, the first input aperture for receiving beaded ice cream and the second input aperture for receiving conventional semi-soft ice cream, wherein the fruit and nut feeder combines the frozen food particles with conventional ice cream in a predetermined ratio and transports the combination to the output aperture; and
a combining mechanism for receiving the frozen food particles from said cryogenic processor and depositing them at the first input aperture.

2. The mechanism of claim 1, further comprising:
a static mixer having an input and output ends.

3. The mechanism of claim 2, wherein the input end is connected to the output of the combining mechanism.

4. The mechanism of claim 3, wherein the combining mechanism forces the combination of food particles and conventional ice cream through the static mixer where it is blended and then transported to the output end, such as through use of a star wheel.

5. The mechanism of claim 4, wherein the combining mechanism ensures that a pre-configurable percentage of food particles are inserted into the semi-frozen soft ice cream, yet regulates the pressure and flow of the mixture so that the food particles are not crushed and a desired level of viscosity is maintained.

6. The mechanism of claim 1, further comprising:
a central control device, connected to both the fruit and nut feeder and the combining mechanism.

7. The mechanism of claim 6, further comprising a mechanism which controls the flow of the semi-liquid conventional ice cream responsive to the central control device.

8. The mechanism of claim 6, wherein the combining mechanism feeds back information regarding pressure and volume to the central control device, which then automatically makes real-time adjustments to both the variable speed fruit and nut feeder as well as to the mechanism which controls the flow of the semi-liquid conventional ice cream.

9. The mechanism of claim 1, wherein the variable speed fruit and nut feeder is connected directly to the outlet of the cryogenic processor.

10. The mechanism of claim 1, wherein the variable speed fruit and nut feeder is connected to a transport mechanism.

11. The mechanism of claim 6, wherein the central control device is located at a standard room temperature environment separate from the food-preparation environment, and information communicated thereto is wirelessly or remotely transmitted to the combining mechanism and other mechanisms.

12. The mechanism of claim 1, wherein the interspersing of the ultra-cold food particles within the conventional ice cream reduces the time the total mixture must spend in a hardening cabinet.

13. The mechanism of claim 1, wherein a container is filled first with a layer of food particles, then a layer of semi-frozen soft ice cream, then another layer of food particles, and then a layer of something else.

14. The mechanism of claim 1, wherein a container is filled from the side rather than from the top, and sealed in such a way that a customer will be immediately presented with a striped pattern of alternating layers of food particles and conventional ice cream upon opening the container.

15. The mechanism of claim 13, wherein the container is translucent plastic.

16. The mechanism of claim 1, wherein the interior of the combining mechanism is evacuated between layers of the dissimilar ice cream compounds, so that a sharp, crisp visual transition between the resulting layers occurs.

17. The mechanism of claim 1, further comprising a twist-lock changeable pattern mechanism, attachable to the output of the combining mechanism.

18. The mechanism of claim 17, wherein the food particles are forced through a changeable pattern stencil mechanism which starts out at the bottom of the empty container and is raised at the same rate that the container is filled.

19. The mechanism of claim 18, wherein the rate at which the food particles and conventional ice cream are pumped into the changeable pattern stencil mechanism and the container is monitored and controlled by the central control device using information obtained from sensors within the pattern mechanism, so that a desired pattern is accurately reproduced throughout the entire container.

20. A mechanism for combining particulate and conventional ice cream, comprising:
a cryogenic processor containing a refrigerant and having input and output locations, wherein the processor receives liquid composition at the input location, and transforms the liquid composition into frozen food particles which are movably directed toward the output location;
a screw-drive apparatus having first and second input apertures and an output aperture, the first input aperture for receiving beaded ice cream and the second input aperture for receiving conventional semi-soft ice cream, wherein the screw-drive apparatus combines the frozen food particles with conventional ice cream in a predetermined ratio and transports the combination to the output aperture; and
a gravity feeder for receiving the frozen food particles from the cryogenic processor and depositing them at the first input aperture.

21. The mechanism of claim 20, wherein the drive motor controls a feed screw having threads, and the distance between the threads of the feed screw and the screw housing is small enough that the food particles only advance when the feed screw is rotating.

22. The mechanism of claim 20, further comprising:
a static mixer having input and output ends.

23. The mechanism of claim 22, wherein the input end is connected to the output of the screw drive apparatus.

24. The mechanism of claim 23, wherein the screw drive apparatus forces the combination of food particles and conventional ice cream through the static mixer where it is blended and then transported to the output end.

25. The mechanism of claim 24, wherein the screw drive apparatus ensures that a pre-configurable percentage of food particles are inserted into the semi-frozen soft ice cream, yet regulates the pressure and flow of the mixture so that the food particles are not crushed and a desired level of viscosity is maintained.

26. The mechanism of claim 20, further comprising:
a central control device, connected to both the gravity feeder and the screw drive apparatus.

27. The mechanism of claim 26, further comprising a mechanism which controls the flow of the semi-liquid conventional ice cream responsive to the central control device.

28. The mechanism of claim 26, wherein the screw drive apparatus feeds back information regarding pressure and volume to the central control device, which then automatically makes real-time adjustments to both the gravity feeder and the screw drive apparatus.

29. The mechanism of claim 20, wherein the gravity feeder is connected directly to the outlet of the cryogenic processor.

30. The mechanism of claim 20, wherein the gravity feeder is connected to a transport mechanism.

31. The mechanism of claim 26, wherein the central control device is located at a standard room temperature environment separate from the food-preparation environment, and information communicated thereto is wirelessly or remotely transmitted to the screw drive apparatus and other mechanisms.

32. The mechanism of claim 20, wherein the interspersing of the ultra-cold food particles within the conventional ice cream reduces the time the total mixture must spend in a hardening cabinet.

33. The mechanism of claim 20, wherein a container is filled first with a layer of food particles, then a layer of semi-frozen soft ice cream, then another layer of food particles, and then a layer of something else.

34. The mechanism of claim 20, wherein a container is filled from the side rather than from the top, and sealed in such a way that a customer will be immediately presented with a striped pattern of alternating layers of food particles and conventional ice cream upon opening the container.

35. The mechanism of claim 33, wherein the container is translucent plastic.

36. The mechanism of claim 20, wherein the interior of the combining mechanism is evacuated between layers of the dissimilar ice cream compounds, so that a sharp, crisp visual transition between the resulting layers occurs.

37. The mechanism of claim 20, further comprising a twist-lock changeable pattern mechanism, attachable to the combining mechanism.

38. The mechanism of claim 37, wherein the food particles are forced through a changeable pattern stencil mechanism which starts out at the bottom of the empty container and is raised at the same rate that the container is filled.

39. The mechanism of claim 26, wherein the rate at which the food particles and conventional ice cream are pumped into the changeable pattern stencil mechanism and the container is monitored and controlled by the central control device using information obtained from sensors within the pattern mechanism, so that a desired pattern is accurately reproduced throughout the entire container.

40. A mechanism for combining particulate and conventional ice cream, comprising:
a cryogenic processor containing a refrigerant and having input and output locations, wherein the processor receives liquid composition at the input location, and transforms the liquid composition into frozen food particles which are movably directed toward the output location;
a modified mixing apparatus containing two separate nozzles.

41. The mechanism of claim 40, wherein the food particles are swirled into the flowing ice cream by modifying the modified mixing apparatus so that the food particles are dropped into the container which is simultaneously but separately being filled with conventional ice cream.

42. The mechanism of claim 40, wherein the nozzle for the food particles can be adapted to rotate, zigzag, or move in a variety of directions so that the food particles are swirled, spirally deposited, or linear deposited in some other type of recognizable pattern involving pre-arranged lines and curves.

43. A method for combining particulate and conventional ice cream, comprising:
transforming a liquid ice cream composition into frozen food particles through a cryogenic processor containing refrigerant and having input and output locations;
combining the frozen food particles with conventional ice cream in a predetermined ration with a gravity feeder having a first aperture for receiving beaded ice cream, a second aperture for receiving conventional semi-soft ice cream, and transporting the combination to an output aperture;
depositing the food particles from the cryogenic processor to the first aperture of the gravity feeder using a combining mechanism.

44. The method of claim 43, further comprising:
blending the combination of food particles and conventional semi-soft ice cream by transporting the combination from the output of the combining mechanism to a static mixer.

45. The method of claim 44, further comprising:
ensuring that a pre-configurable percentage of food particles are inserted into the semi-frozen soft ice cream in the static mixer.

46. The method of claim 45, further comprising:
regulating the pressure and flow of the mixture so that the food particles are not crushed and a desired level of viscosity is maintained.

47. The method of claim 43, further comprising:
controlling the flow of the semi-liquid conventional ice cream through a central control device, connected to both the gravity feeder and the combining mechanism.

48. The method of claim 43, further comprising:
feeding back information from the combining mechanism to the central control device regarding pressure and volume of ice cream in the combining mechanism.

49. The method of claim 48, further comprising:
adjusting the variable speed gravity feeder as well as the mechanism which controls the flow of the semi-liquid conventional ice cream in response to the feedback to the central control device.

50. The method of claim 47, further comprising:
wirelessly communicating or remotely transmitting information about conditions inside the machine to and from the central control device, located at a standard room temperature environment separate from the food-preparation environment.

51. The method of claim 43, further comprising:
reducing the time the total mixture must spend in a hardening cabinet by interspersing the food particles within the conventional ice cream.

52. The method of claim 43, further comprising:
filling a container first with a layer of food particles, then filling that container with a later of semi-frozen soft ice cream, then filling the container with another layer of food particles, then filling the container with something else.

53. The method of claim 43, further comprising:
filling the container from the side rather than from the top and sealing the container in such a way that a customer will be immediately presented with a striped pattern of alternating layers of food particles and conventional ice cream upon opening the container.

54. The method of claim 52, further comprising:
depositing the product in a translucent plastic container.

55. The method of claim 43, further comprising:
evacuating the interior of the combining mechanism between layers of the dissimilar ice cream compounds, so that a sharp, crisp visual transition between the resulting layers occurs.

56. The method of claim 43, further comprising:
attaching a twist-lock changeable pattern mechanism to the output of the combining mechanism.

57. The method of claim 56, further comprising:
forcing the food particles through a changeable pattern stencil mechanism, starting at the bottom of the empty container and raising the stencil at the same rate the container is filled.

58. The method of claim 57, further comprising:
obtaining information from sensors within the pattern mechanism, and transferring this information to the central control device.

59. The method of claim 58, further comprising:
monitoring and controlling the rate at which the food particles an conventional ice cream are pumped into the changeable pattern stencil mechanism and the container, using the information sent to the central control device from the sensors, and thus accurately reproducing a desired pattern throughout the entire container.

60. A method for combining food particles and conventional ice cream, comprising:
transforming a liquid composition input into a cryogenic processor containing a refrigerant into frozen food particles which are movably directed toward an output location on the cryogenic processor;
transporting the frozen food particles to a modified mixing apparatus containing two separate nozzles.

61. The method of claim 60, further comprising:
swirling the food particles into the flowing cream so that the food particles are dropped into the container which is simultaneously but separately being filled with conventional ice cream.

62. The method of claim 60, further comprising:
rotating or zigzagging the nozzle for the food particles such that swirling, spirally depositing, or linearly depositing the food particles in some other type of recognizable pattern having pre-arranged lines and curves occurs.
